(19) United States
(12) Patent Application Publication
(10) Pub. No.: US 2026/0362563 A1
(43) Pub. Date: Nov. 12, 2026

(54) COOKING APPLIANCE FAN BLOWER BRACKET

(71) Applicant: Haier US Appliance Solutions, Inc., Wilmington, DE (US)

(72) Inventor: Bagawathkumar Chellappan, Prospect, KY (US)

(21) Appl. No.: 19/200,819

(22) Filed: May 7, 2025

(51) Int. Cl. H05B 6/64

(52) U.S. Cl. CPC H05B 6/6423

(57) ABSTRACT

A cooking appliance includes a casing defining a cooking chamber and a circulation conduit including an inlet and outlet. Additionally, the appliance includes a door. Furthermore, the appliance includes a fan assembly positioned within the circulation conduit. The assembly includes a discharge housing including first and second discharge housing sections. The second discharge housing section is spaced apart from the first discharge housing section. Additionally, the discharge housing includes a discharge port defined through the first and/or second discharge housing section. Furthermore, the assembly includes an impeller rotatably mounted within the fan housing. Rotation of the impeller circulates air through the discharge port. Moreover, the assembly includes a blower bracket. The bracket is positioned on and coupled to the first and second discharge housing sections, whereby relative movement between the first discharge housing section, the second discharge housing section, and the blower bracket is constrained.

### FIELD

The present subject matter relates generally to cooking appliances, and more particularly to fans in over-the-range cooking appliances.

### BACKGROUND

Over-the-range cooking appliances, such as over-the-range microwave appliances, are generally mounted above a cooktop of an oven range appliance. In addition to providing for heating of food and beverage items, certain over-the-range microwave appliances include a circulation system. When activated, the circulation system can draw fumes, smoke, grease, and/or steam away from the cooktop of the oven range appliance. Circulation systems generally include a fan for drawing a flow of air into the circulation system and a grease filter for trapping grease entering the circulation system.

Over-the-range microwave appliances generally have a radial blower fan that can be adjusted to recirculate or externally vent through an air vent. The installer of the microwave appliance can adjust the blower fan by removing certain parts to access and remove the radial blower fan, in order to reposition the fan. In other words, to switch venting directions after installation of the microwave appliance, the microwave appliance needs to be uninstalled and then reinstalled with the fan repositioned to change the venting direction. At times, installers may overlook ducting in the home and install the microwave appliance without properly orienting the blower fan to the functional position. This can lead to the failure of the magnetron and the cooking air not being vented in the desired direction for the consumer.

Accordingly, a cooking appliance with features for adjusting the circulation of the cooking appliance without uninstalling and reinstalling the fan would be useful.

### BRIEF DESCRIPTION

Aspects and advantages of the invention will be set forth in part in the following description, or may be apparent from the description, or may be learned through practice of the invention.

In accordance with one exemplary embodiment of the present disclosure, a cooking appliance is provided. The cooking appliance includes a casing. The casing defines a cooking chamber for receipt of food items for cooking. The casing also defines a circulation conduit. The circulation conduit includes an inlet and an outlet. Additionally, the cooking appliance includes a door. The door is mounted to the casing for permitting selective access to the cooking chamber. Furthermore, the cooking appliance includes a fan assembly. The fan assembly is positioned within the circulation conduit. The fan assembly includes a discharge housing. The discharge housing includes a first discharge housing section. Moreover, the discharge housing includes a second discharge housing section spaced apart from the first discharge housing section. Additionally, the discharge housing includes a discharge port defined through at least one of the first discharge housing section or the second discharge housing section. Furthermore, the fan assembly includes an impeller. The impeller is rotatably mounted within the fan housing. Rotation of the impeller circulates air through the discharge port. Moreover, the fan assembly includes a blower bracket. The blower bracket includes a first plate. Additionally, the blower bracket includes a second plate coupled to and extending orthogonally from the first plate. The blower bracket is positioned on and coupled to the first discharge housing section and the second discharge housing section, whereby relative movement between the first discharge housing section, the second discharge housing section, and the blower bracket is constrained.

In accordance with another exemplary embodiment of the present disclosure, a cooking appliance is provided. The cooking appliance includes a casing. The casing defines a cooking chamber for receipt of food items for cooking. The casing also defines a circulation conduit. The circulation conduit includes an inlet and an outlet. Additionally, the cooking appliance includes a door. The door is mounted to the casing for permitting selective access to the cooking chamber. Furthermore, the cooking appliance includes a fan assembly. The fan assembly is positioned within the circulation conduit. The fan assembly includes a discharge housing. The discharge housing includes a first discharge housing section. Moreover, the discharge housing includes a second discharge housing section spaced apart from the first discharge housing section. Additionally, the discharge housing includes a discharge port defined through at least one of the first discharge housing section or the second discharge housing section. Furthermore, the fan assembly includes an impeller. The impeller is rotatably mounted within the fan housing. Rotation of the impeller circulates air through the discharge port. Moreover, the fan assembly includes a blower bracket. The blower bracket is positioned on and coupled to the first discharge housing section and the second discharge housing section, whereby relative movement between the first discharge housing section, the second discharge housing section, and the blower bracket is constrained.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of an example cooking appliance according to an example embodiment of the present subject matter mounted to a kitchen cabinet above an oven range appliance.

FIG. 2 provides a side, section view of the example cooking appliance and the oven range appliance of FIG. 1.

FIG. 3 provides a perspective view of a fan assembly of a cooking appliance, such as the example cooking appliance of FIG. 1.

FIG. 4 provides an exploded perspective view of the fan assembly of FIG. 3.

FIG. 5 provides a front view of the fan assembly of FIG. 3.

FIG. 6 provides a side view of the fan assembly of FIG. 3.

FIG. 7 provides a perspective view of an example embodiment of an example cooking appliance with the fan assembly of FIG. 3 in a first position.

FIG. 8 provides a perspective view of an example embodiment of an example cooking appliance with the fan assembly of FIG. 3 in a second position.

FIG. 9 provides a perspective view of an example embodiment of an example cooking appliance with the fan assembly of FIG. 3 in a third position.

FIG. 10 provides a front cross-sectional view of the fan assembly of FIG. 3.

FIG. 11 provides a close-up front cross-sectional view of the fan assembly of FIG. 3.

FIG. 12 provides a perspective view of an example cooking appliance and the fan assembly of FIG. 3 with a tension member connected between a drive wheel of the fan assembly and an adjustable fan control knob.

FIG. 13 provides a perspective view of the fan assembly of FIG. 3 with the tension member connected between the drive wheel of the fan assembly and the adjustable fan control knob.

FIG. 14 provides a perspective view of the fan assembly of FIG. 3 with the tension member connected to the drive wheel.

FIG. 15 provides a close-up perspective view of the drive wheel of the fan assembly of FIG. 3.

FIG. 16 provides a close-up perspective view of an example tension member guide of the fan assembly of FIG. 3.

FIG. 17 provides a perspective view of the fan assembly of FIG. 3 with an example motor drive assembly mounted to the fan assembly.

FIG. 18 provides a side partial cross-sectional view of the fan assembly of FIG. 3 with the motor drive assembly of FIG. 17 mounted to the fan assembly.

FIG. 19 provides a front partial cross-sectional view of the fan assembly FIG. 3 with a portion of the motor drive assembly of FIG. 17 mounted to the fan assembly.

FIG. 20 provides a close-up front cross-sectional view of the fan assembly of FIG. 3.

FIG. 21 provides a perspective view of the fan assembly of FIG. 3.

FIG. 22 provides a close-up front cross-sectional view of the fan assembly of FIG. 3.

FIG. 23 provides a perspective view of the fan assembly of FIG. 3 with an example blower bracket attached to the fan assembly.

FIG. 24 provides an exploded perspective view of the blower bracket of FIG. 23 separated from the fan assembly of FIG. 3.

FIG. 25 provides a close-up rear view of the fan assembly of FIG. 3 with blower bracket locating protrusions.

FIG. 26 provides a close-up rear view of the fan assembly of FIG. 3 with blower bracket locating protrusions.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). The term “at least one of” in the context of, e.g., “at least one of A, B, and C” refers to only A, only B, only C, or any combination of A, B, and C. In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

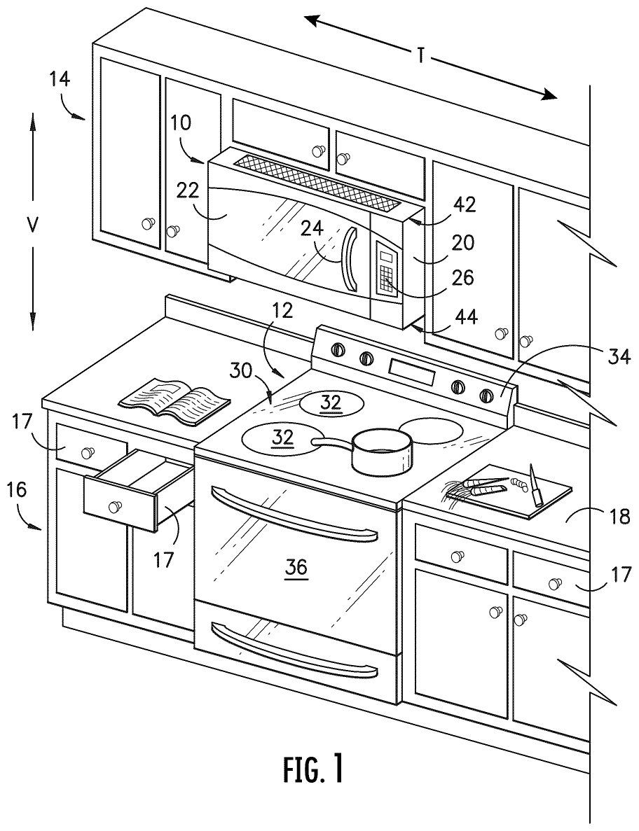

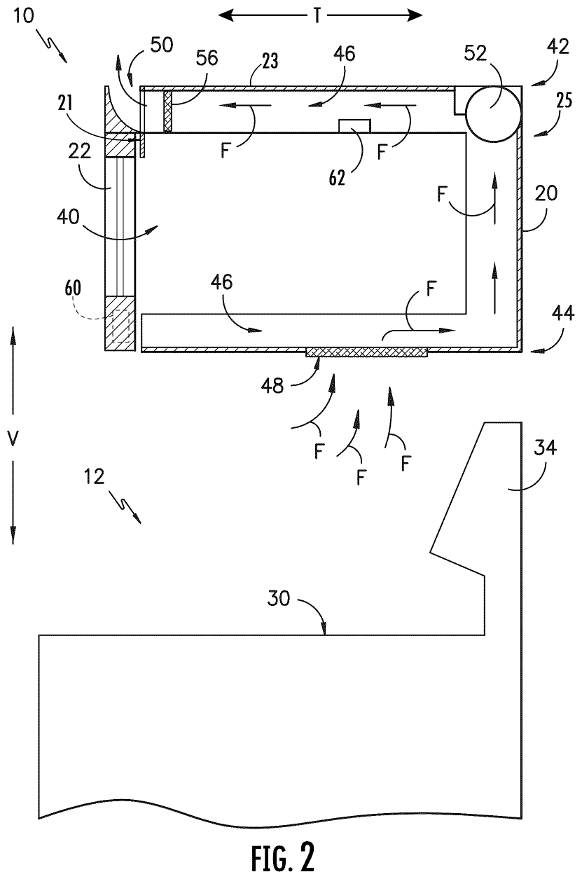

FIG. 1 provides a perspective view of a cooking appliance, described herein as a microwave appliance 10, according to an example embodiment of the present subject matter. Microwave appliance 10 generally defines a vertical direction V, a lateral direction L, and a transverse direction T (FIG. 2), each of which is mutually perpendicular, such that an orthogonal coordinate system is generally defined. Microwave appliance 10 is shown in FIG. 1 mounted to an upper set of kitchen cabinets 14 above an oven range appliance 12, e.g., along the vertical direction V. Microwave appliance 10 shown in FIG. 1 is commonly referred to as an over-the-range microwave. It should be understood that, in alternative example embodiments, the present subject matter may be used in any other suitable cooking appliance, such as an oven appliance or any other suitable microwave appliance.

As discussed above, microwave appliance 10 is mounted to upper set of kitchen cabinets 14. Upper set of kitchen cabinets 14 is positioned above a base set of kitchen cabinets 16, e.g., along the vertical direction V. Base set of kitchen cabinets 16 includes countertops 18 and drawers 17. Microwave appliance 10 is positioned above base set of kitchen cabinets 16, e.g., along the vertical direction V. Oven range appliance 12 is received within base set of kitchen cabinets 16 below microwave appliance 10. In particular, a cooking surface 30 of oven range appliance 12 is positioned, e.g., directly, below microwave appliance 10 along the vertical direction V. Microwave appliance 10 can include features such as an air handler or fan assembly 52 (FIG. 2) that can draw cooking vapors and/or smoke away from cooking surface 30 and out of the kitchen containing microwave and oven range appliances 10 and 12.

Microwave appliance 10 is configured for receipt of food items for cooking. In particular, microwave appliance 10 includes a cabinet or casing 20 and a door 22 that permits selective access to an interior of microwave appliance 10 and casing 20. Door 22 includes a handle 24 that a user can pull to open door in order to insert food items into microwave appliance 10. Microwave appliance 10 also includes controls 26 that permit a user to make selections for cooking of food items, e.g., a duration of a cooking cycle of microwave appliance 10 and/or a power setting for the cooking cycle of microwave appliance 10.

As discussed above, oven range appliance 12 includes cooking surface 30. Cooking surface 30 includes heated portions 32 that may be heated by heating elements (not shown), e.g., electrical resistive heating elements, gas burners, induction heating elements, and/or any other suitable heating element or combination of heating elements. Oven range appliance 12 also includes a door 36 that permits access to a heated compartment (not shown) of oven range appliance 12, e.g., for cooking or baking of food items therein. A control panel 34 of oven range appliance 12 can permit a user to make selections for cooking of food items, e.g., a duration of a cooking cycle of oven range appliance 12 and/or a power setting for the cooking cycle of oven range appliance 12.

FIG. 2 provides a side, section view of microwave appliance 10 and oven range appliance 12. As may be seen in FIG. 2, casing 20 extends between a top portion 42 and a bottom portion 44, e.g., along the vertical direction V. Thus, top and bottom portions 42 and 44 of casing 20 are spaced apart from each other, e.g., along the vertical direction V. In particular, casing 20 may include a front wall 21, a top wall 23, and a back wall 25 as will be described further hereinbelow. Casing 20 may generally define a cooking chamber 40 configured for receipt of food items for cooking. Door 22, which may be positioned adjacent to front wall 21 of casing 20 of microwave appliance 10, permits selective access to cooking chamber 40 of casing 20. In particular, door 22 of microwave appliance 10 is selectively adjustable between an open position (not shown) and a closed position (FIGS. 1 and 2). In the closed position, door 22 of microwave appliance 10 hinders access to cooking chamber 40 of casing 20. Conversely, door 22 of microwave appliance 10 permits access to cooking chamber 40 of casing 20 in the open position. A user can pull on handle 24 of door 22 of microwave appliance 10 in order to shift door 22 from the closed position shown in FIG. 2 to the open position.

Casing 20 also defines a circulation passage or conduit 46. Circulation conduit 46 has an inlet 48 and an outlet 50. Circulation conduit 46 extends between inlet 48 and outlet 50. Inlet 48 of circulation conduit 46 is positioned at or adjacent bottom portion 44 of casing 20, e.g., such that inlet 48 of circulation conduit 46 faces cooking surface 30 of oven range appliance 12. Conversely, outlet 50 of circulation conduit 46 is positioned at or adjacent top portion 42 of casing 20, e.g., such that outlet 50 of circulation conduit 46 faces away from cooking surface 30 of oven range appliance 12. Thus, inlet 48 and outlet 50 of circulation conduit 46 are spaced apart from each other, e.g., along the vertical direction V.

Microwave appliance 10 may include a fan assembly 52, such as an axial fan or a radial fan. Fan assembly 52 may be positioned within or adjacent circulation conduit 46. Fan assembly 52 may draw or urge a flow of air (shown with arrows F) through circulation conduit 46 when fan assembly 52 is in an activated state. Conversely, fan assembly 52 may not draw or urge flow of air F through circulation conduit 46 when fan assembly 52 is in a deactivated state. When fan assembly 52 is in the activated state, flow of air F enters circulation conduit 46 at, or through, inlet 48 of circulation conduit 46. In the present example embodiment, flow of air F is directed through circulation conduit 46 to outlet 50, and flow of air F can exit circulation conduit 46 at outlet 50 of circulation conduit 46. As described above, fan assembly 52 is described in a recirculation orientation where flow of air F is directed through circulation conduit 46 to outlet 50, however, fan assembly 52 may be configurable to direct flow of air F in other desired directions. Fan assembly 52, and other possible orientations of fan assembly 52 will be described in further detail hereinbelow.

Microwave appliance 10 may also include an air filter 56. Air filter 56 may be mounted to casing 20 such that flow of air F within circulation conduit 46 passes through air filter 56 when fan assembly 52 is in the activated state. In the example embodiment shown in FIG. 2, air filter 56 is positioned within circulation conduit 46 at outlet 50 of circulation conduit 46. It should be understood that in alternative example embodiments, air filter 56 may be positioned at any other suitable location on microwave appliance 10.

As may be seen in FIG. 2, microwave appliance 10 includes a controller 60. Operation of microwave appliance 10 is regulated by controller 60. Controller 60 is operatively coupled or in communication with various components of microwave appliance 10, including controls 26. In response to user manipulation of controls 26, controller 60 operates the various components of microwave appliance 10 to execute selected cycles and features.

Controller 60 may include a memory and microprocessor, such as a general or special purpose microprocessor operable to execute programming instructions or micro-control code associated with a cleaning cycle. The memory may represent random access memory such as DRAM, or read only memory such as ROM or FLASH. In one embodiment, the processor executes programming instructions stored in memory. The memory may be a separate component from the processor or may be included onboard within the processor. Alternatively, controller 60 may be constructed without using a microprocessor, e.g., using a combination of discrete analog and/or digital logic circuitry (such as switches, amplifiers, integrators, comparators, flip-flops, AND gates, and the like) to perform control functionality instead of relying upon software. Controls 26 and other components of microwave appliance 10 may be in communication with controller 60 via one or more signal lines or shared communication busses.

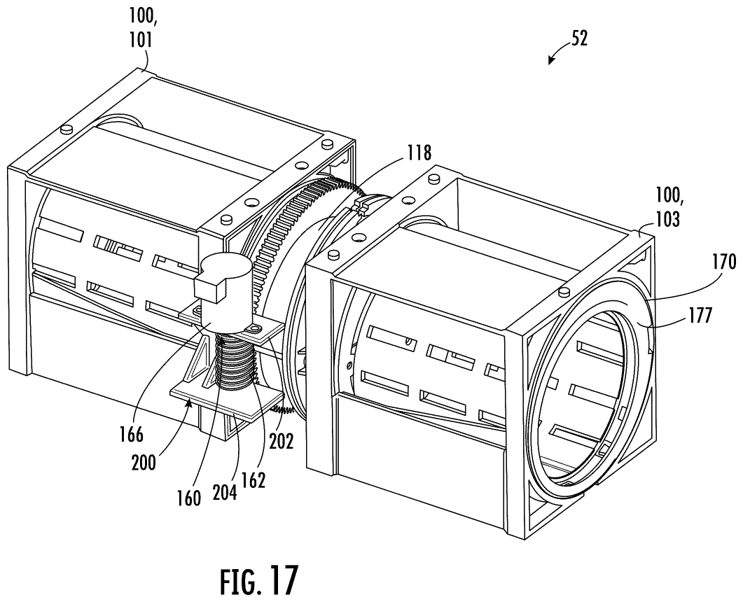

Microwave appliance 10 also includes a magnetron 62. Magnetron 62 is configured for generating microwaves and directing such microwaves towards or into cooking chamber 40 of casing 20. Magnetron 62 can be positioned at any suitable location within microwave appliance 10. For example, magnetron 62 may be mounted to casing 20, e.g., at or adjacent top portion 42 of casing 20, such that magnetron 62 is positioned at or adjacent cooking chamber 40 of casing 20. Controller 60 can selectively activate magnetron 62, e.g., in order to heat food or beverage items in cooking chamber 40, based at least in part on an activation signal received from controls 26. Further, controller 60 may also be in operative communication with fan assembly 52. For example, controller 60 may be in operative communication with a motor 166 of a motor drive assembly 160 (FIGS. 17-19) coupled to fan assembly 52. Thus, controller 60 may selectively adjust fan assembly 52, e.g., by motor 166, between the activated and deactivated states in order to regulate the flow of air F through circulation conduit 46.

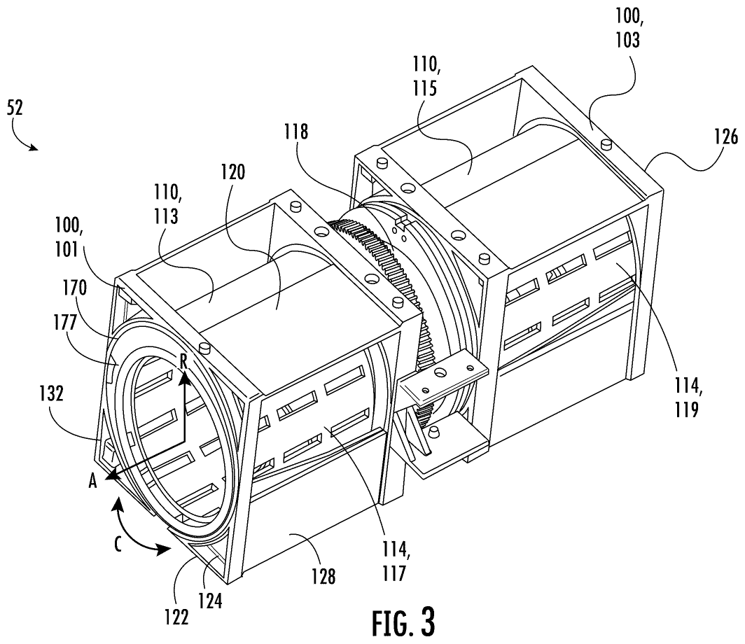

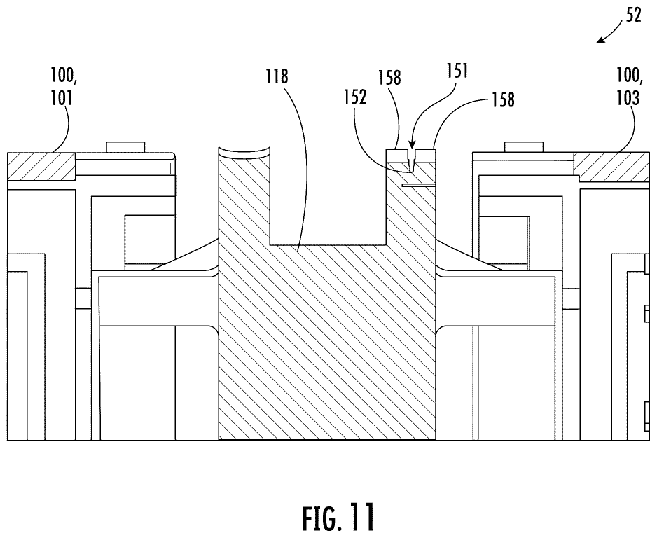

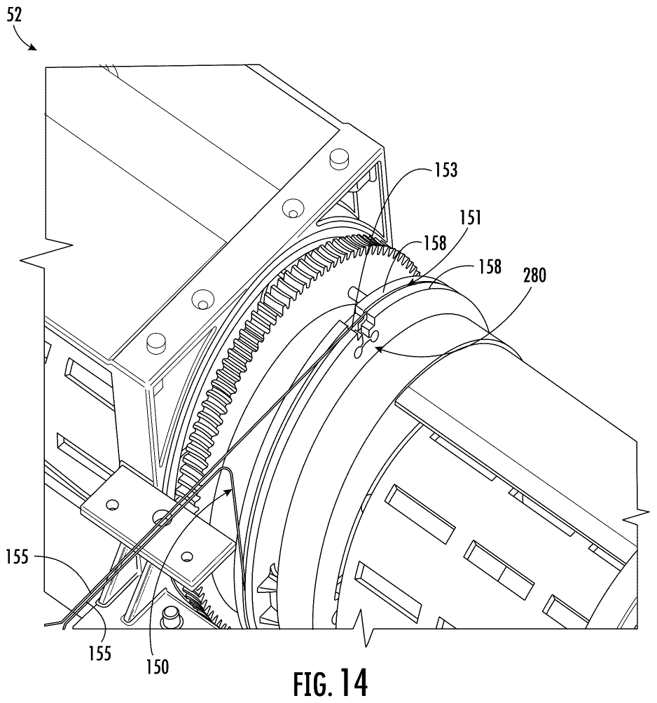

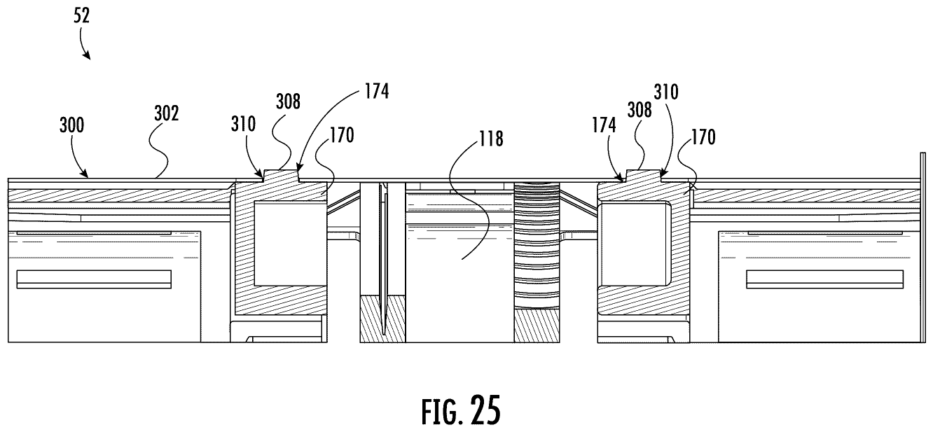

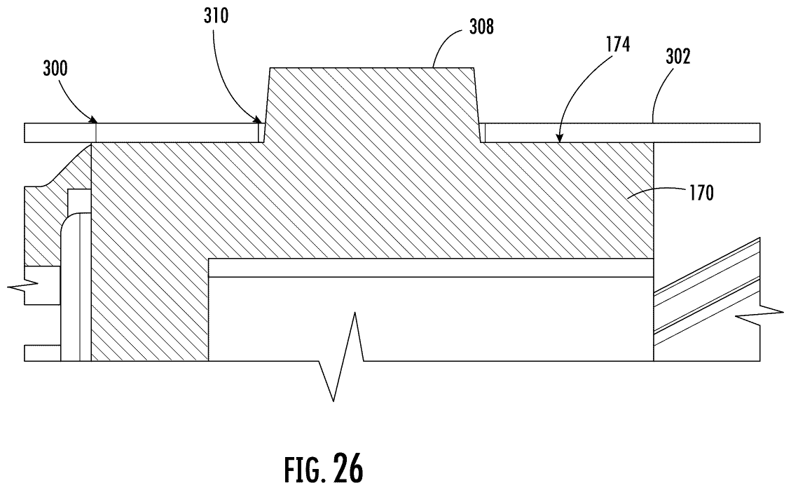

Illustrated in FIGS. 3 through 26 is an example embodiment of fan assembly 52 for use with a cooking appliance, such as microwave appliance 10. While described herein as used with microwave appliance 10, it should be appreciated that additionally, or alternatively, fan assembly 52 may be used in other cooking appliances such as oven appliances and/or other suitable appliances or structures such as heating, ventilation, and air conditioning systems (HVAC) or vent hood appliances.

As best illustrated in FIGS. 3 through 9, fan assembly 52 may include a discharge housing 100. In general, discharge housing 100 may extend between a top side 120, a bottom side 122, a first side wall 124, a second side wall 126, a front side 128, and a back side 132, e.g., discharge housing 100 may be generally rectangular in shape. Discharge housing 100 may be divided into two sections in the lateral direction L, e.g., discharge housing 100 may be two independent sections, a first discharge housing section 101 and a second discharge housing section 103, separated by a drive wheel 118 as described below. As such, drive wheel 118 may be positioned or sandwiched between first discharge housing section 101 and second discharge housing section 103 of discharge housing 100. In general, discharge housing 100 may be symmetrical across drive wheel 118 in order to provide modularity of fan assembly 52. However, while described herein as having two independent sections, it should be appreciated that, in some embodiments, discharge housing 100 may include a single section, e.g., first discharge housing section 101. In this respect, drive wheel 118 may be mounted to the single discharge housing section, e.g., to an outside portion thereof.

According to some example embodiments, discharge housing 100 may generally define a plurality of discharge ports, e.g., a first discharge port 102, a second discharge port 104, and a third discharge port 106. In example embodiments, the plurality of discharge ports 102, 104, and 106 includes three discharge ports, first discharge port 102, second discharge port 104, and third discharge port 106, facing in different directions. In general, the plurality of discharge ports 102, 104, and 106 may be oriented in any suitable direction. For example, first discharge port 102 may be defined in front side 128 of discharge housing 100 (e.g., the first discharge port 102 may generally face forward along the transverse direction T), second discharge port 104 may be defined in top side 120 of discharge housing 100 (e.g., the second discharge port 104 may generally face upward along the vertical direction V), and third discharge port 106 may be defined in back side 132 of discharge housing 100 (e.g., the third discharge port 106 may generally face backward along the transverse direction T). In some embodiments, the plurality of discharge ports 102, 104, and 106 may each be defined as pairs of discharge ports, such as one port on each section of discharge housing 100 forming pairs of discharge ports such that discharge housing 100 is symmetrical across drive wheel 118. However, in embodiments in which the discharge housing 100 includes a single section, the discharge housing 100 may define only one of each discharge port 102, 104, and 106.

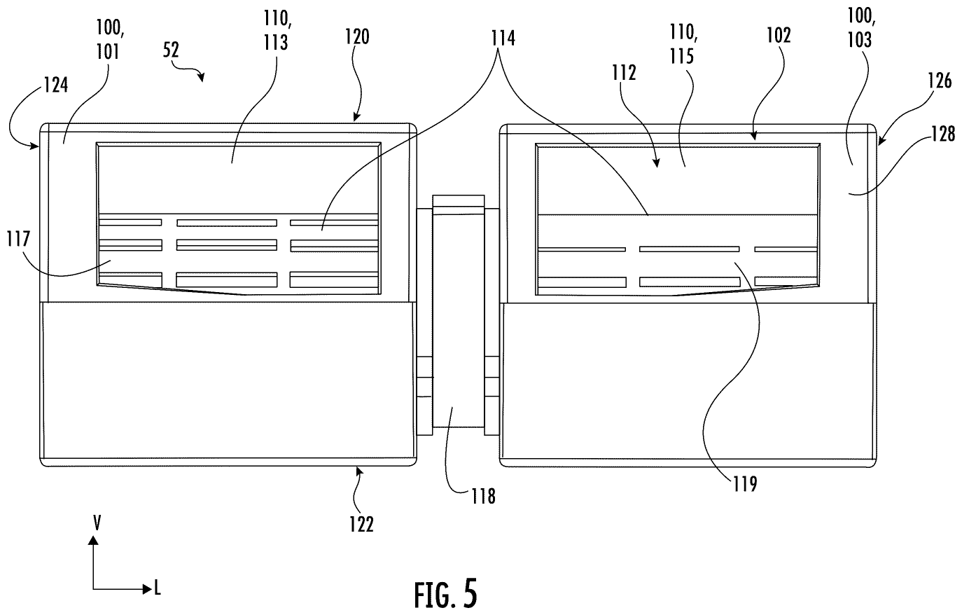

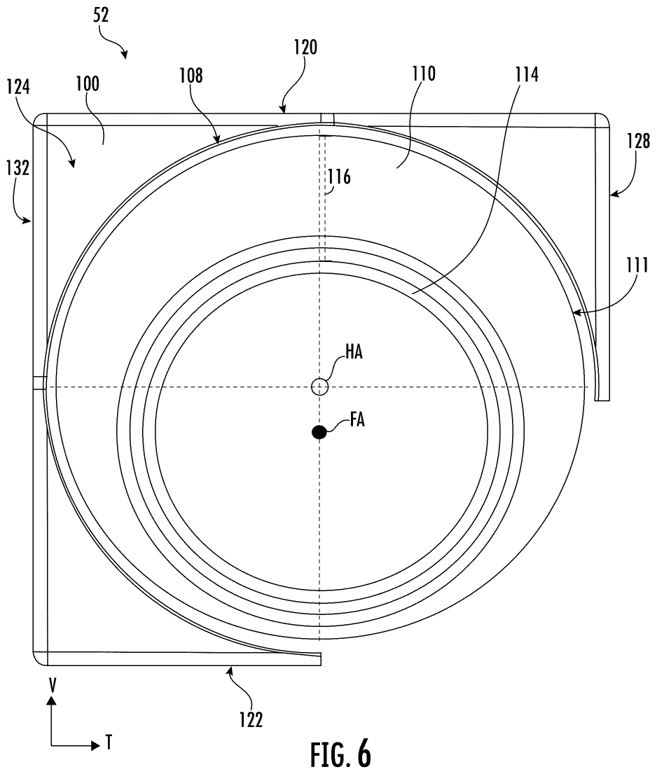

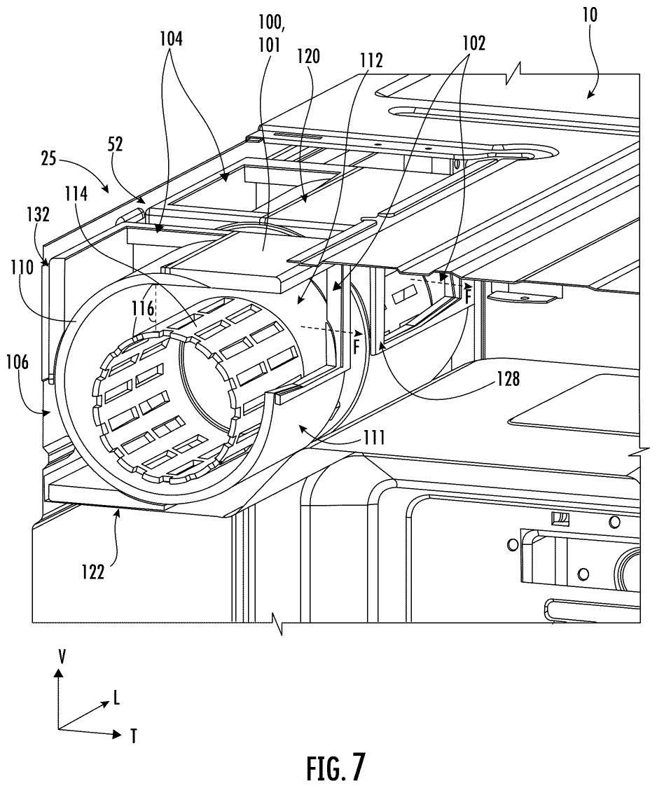

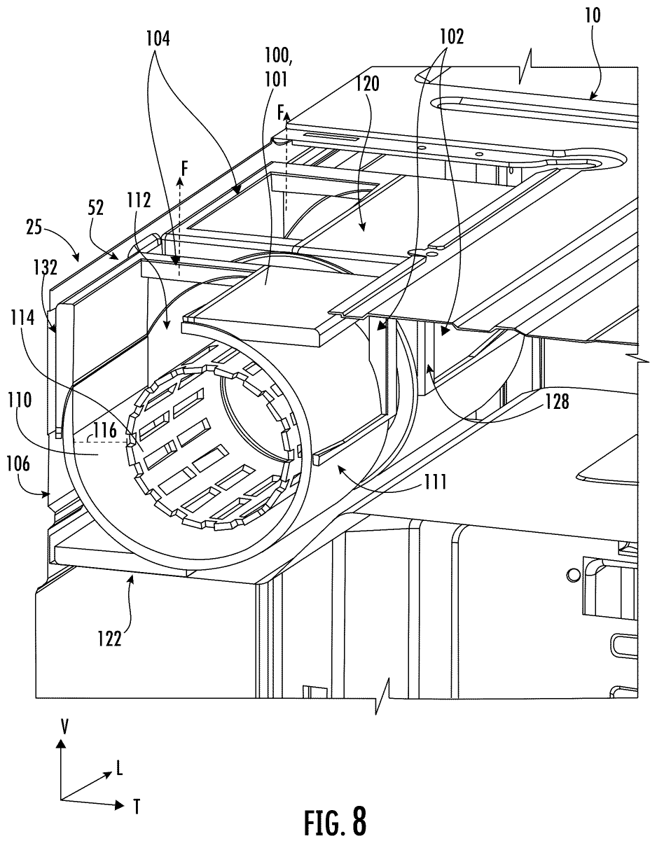

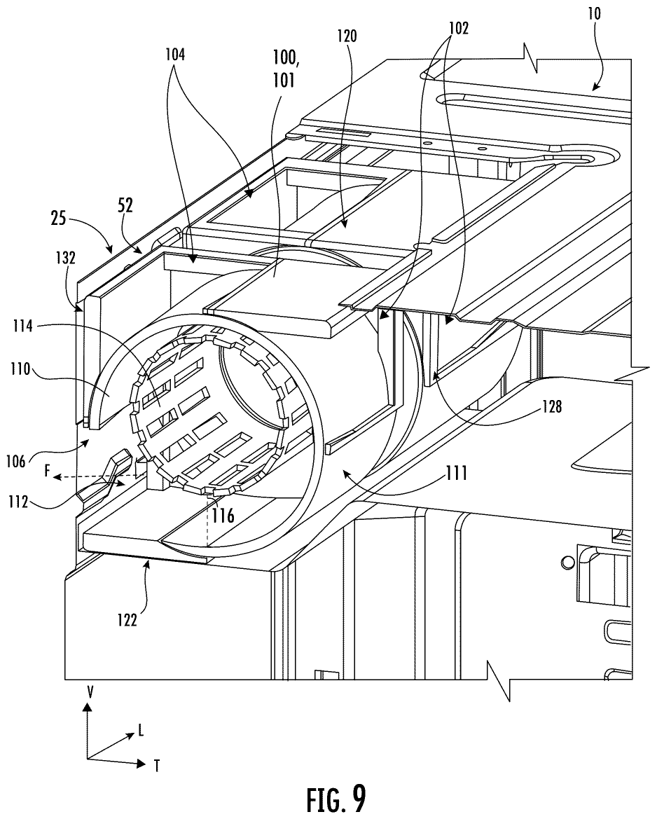

As best illustrated in FIGS. 3 and 5, a fan housing 110 may be mounted within discharge housing 100, e.g., fan housing 110 may include two sections, a first fan housing section 113 and a second fan housing section 115, one on each side of drive wheel 118, e.g., one in each section, first discharge housing section 101 and second discharge housing section 103 respectively, of discharge housing 100. In particular, as best illustrated in FIG. 6, discharge housing 100 may include an opening 108, e.g., a cylindrically shaped opening in each of first side wall 124 and second side wall 126 of discharge housing 100. Fan housing 110 may include an outer surface 111 and may be cylindrical, and concentric with opening 108 of discharge housing 100, such that fan housing 110 fits within opening 108 in both of the transverse direction T and vertical direction V. In other words, fan housing 110 may be laterally, in the lateral direction L, positioned within, and rotatable within, opening 108 of the discharge housing 100. For example, in the present example embodiment, fan housing 110 may be selectively rotatable within discharge housing 100. In particular, fan housing 110 may include an outlet 112, in each respective section within discharge housing 100, configured to align with a selected one of the plurality of discharge ports 102, 104, and 106. For example, fan housing 110 may be rotatable between a first position (as seen in FIG. 7), wherein outlet 112 is aligned with first discharge port 102 and flow of air F is directed through first discharge port 102, a second position (as seen in FIG. 8), wherein outlet 112 is aligned with second discharge port 104 and flow of air F is directed through second discharge port 104, and a third position (as seen in FIG. 9), wherein outlet 112 is aligned with third discharge port 106 and flow of air F is directed through third discharge port 106. Notably, fan housing 110 may be rotatable within discharge housing 100 while the discharge housing 100 and fan housing 110 are installed within microwave appliance 10. In example embodiments in which fan housing 110 is flexible, fan housing 110 may compress during rotation and spring back to its original position in order to align with the desired discharge port.

Furthermore, in some example embodiments, fan housing 110 may be any other suitable shape, such as a cube, cuboid, prism, etc. Furthermore, fan housing 110 may be made, at least partially, from any suitable rigid or flexible fire-retardant metal material, such as steel, nickel, titanium, iron, or some metal alloy combination thereof. Additionally, the fan housing 110 may be made, at least partially, using hot-rolled metal, cold-rolled metal, cast iron, and/or stainless steel.

Referring again to FIGS. 3 through 9, in general, fan housing 110 may include an impeller 114, e.g., in each section of fan housing 110. For example, a first impeller 117 may be positioned in first fan housing section 113 and a second impeller 119 may be positioned in second fan housing section 115. In particular, impeller 114 may be rotatably mounted within fan housing 110 such that impeller 114 may be configured to circulate air through outlet 112 of fan housing 110 and the selected one of the plurality of discharge ports 102, 104, and 106. For example, impeller 114 may be mechanically coupled to drive wheel 118 which, as will be described below, may be rotatable by a tension member or, alternatively, by a motor. The drive wheel 118 is generally configured to rotate impeller 114 within fan housing 110. As best illustrated in FIG. 6, impeller 114 may be mounted within fan housing 110 on a fan axis FA parallel to, and spaced apart from, a housing axis HA of the fan housing. As such, an inside gap 116 of fan housing 110 from impeller 114 may be non-uniform and progressively increasing towards outlet 112 of the fan housing 110. For example, as explained above, fan housing 110 may be selectively rotatable within discharge housing 100 between the plurality of discharge ports 102, 104, and 106, and offsetting fan axis FA from housing axis HA may thereby keep inside gap 116 of fan housing 110 from impeller 114 non-uniform and progressively increasing towards outlet 112 of fan housing 110 with respect to the selected one of the plurality of discharge ports 102, 104, and 106.

As described above, fan housing 110 may be rotatable between a first position in which outlet 112 is aligned with first discharge port 102, a second position in which outlet 112 is aligned with second discharge port 104, and a third position where outlet 112 is aligned with third discharge port 106. As illustrated in FIG. 7, fan housing 110 is shown in the first position, with outlet 112 aligned with first discharge port 102. When in the first position, flow of air F may flow out of first discharge port 102 of discharge housing 100 in the transverse direction T. Additionally, first discharge port 102 may be aligned with circulation conduit 46 such that, when in the first position, air may be recirculated through circulation conduit 46 (e.g., as seen in FIG. 2). As illustrated in FIG. 8, fan housing 110 is shown in the second position, with outlet 112 aligned with second discharge port 104. When in the second position, flow of air F may flow out of second discharge port 104 of discharge housing 100 in the vertical direction V, such that flow of air F may flow out an external duct (not shown) extending in the vertical direction V. Further, as illustrated in FIG. 9, fan housing 110 is shown in the third position, with outlet 112 aligned with third discharge port 106. When in the third position, flow of air F may flow out of third discharge port 106 of discharge housing 100 in the transverse direction T, opposite the direction of the first position, such that flow of air F may flow out back side 132 of discharge housing 100 and out an external duct (not shown) in the transverse direction T.

According to some example embodiments, fan assembly 52 includes drive wheel 118. The drive wheel 118 generally defines a radial direction R (FIG. 3), an axial direction A (FIG. 3), and a circumferential direction C (FIG. 3) such that a cylindrical coordinate system is generally defined. The term “radial” refers to the relative direction that is substantially perpendicular to an axial centerline of drive wheel 118. The term “axially” refers to the relative direction that is substantially parallel and/or coaxially aligned to an axial centerline of drive wheel 118. The term “circumferentially” refers to the relative direction that extends around the axial centerline of drive wheel 118.

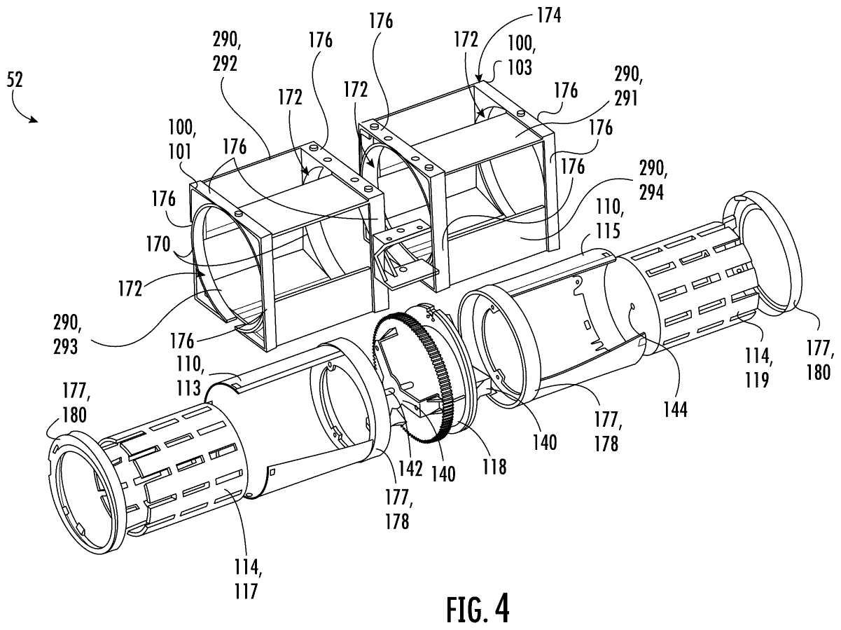

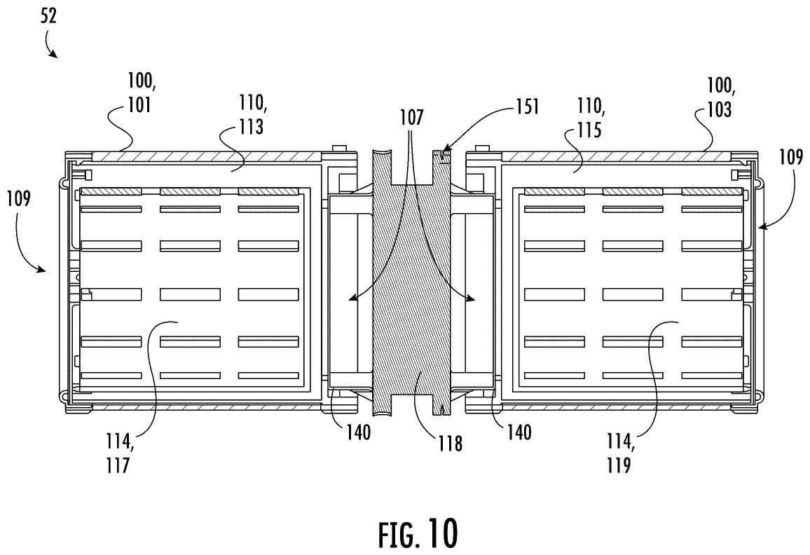

In general, fan housing 110 may be selectively rotatable within discharge housing 100 while installed within microwave appliance 10 by rotating drive wheel 118. For example, as best illustrated in FIGS. 4 and 10, drive wheel 118 may include a mounting structure 140 protruding from a side of the drive wheel 118. The fan housing 110 may be coupled to or mounted on the mounting structure 140 such as by receiving fasteners, e.g., bolts, through aligned pairs of holes of an inner fan housing ring 178 coupled to the fan housing 110 and the mounting structure 140. As illustrated, in some embodiments, drive wheel 118 may be positioned or sandwiched between first discharge housing section 101 and second discharge housing section 103. As such, drive wheel 118 may include two mounting structures 140, one protruding from opposite lateral sides of drive wheel 118, such that first fan housing section 113 and second fan housing section 115 may be coupled to the drive wheel 118. Additionally, a shaft 142 may protrude from the side of the drive wheel 118, such as from the lateral side as shown in FIG. 4. The shaft 142 may be received through the impeller 114, e.g., a shaft hole 144 thereof, and fixed to the impeller 114. In this respect, rotation of the drive wheel 118 also rotates the impeller 114. As illustrated, drive wheel 118 may include two shafts 142, one protruding from the opposite lateral sides of drive wheel 118 that the mounting structures 140 protrude from, such that first impeller 117 and second impeller 119 may be coupled to the drive wheel 118. While described herein as positioned/sandwiched between first discharge housing section 101 and second discharge housing section 103, it should be appreciated that, in some other embodiments, drive wheel 118 may be positioned at any other suitable location, such as at first side wall 124 or second side wall 126.

Referring to FIGS. 10 through 16, notably, in some example embodiments, drive wheel 118 may be rotatable, such as manually rotatable. For example, a user may adjust or move a fan control knob, such as fan control knob 260 of microwave appliance 10, which is connected to a tension member 150. Tension member 150 may be connected between and to drive wheel 118 and fan control knob 260. In this respect, adjustment or movement of the fan control knob 260 may move the tension member 150 which, in turn, rotates the drive wheel 118. As such, drive wheel 118 may include a contact surface 152. The contact surface 152 may extend circumferentially around the drive wheel 118. Tension member 150 may engage at least a portion of the contact surface 152 of drive wheel 118. For example, tension member 150 may be looped around a portion of drive wheel 118 and, as such, may contact a portion of the contact surface 152. The tension member 150 may be utilized to provide tension/tensile force to rotate drive wheel 118 and, thus, fan housing 110 and impeller 114. As such, movement of tension member 150 rotates drive wheel 118 and, thus, fan housing 110 and impeller 114. The tension member 150 may be any suitable tension member such as a rope, cable, chain, belt, and/or the like. However, while described herein as manually rotatable by a tension member, e.g., tension member 150, it should be appreciated that, in some other embodiments, drive wheel 118 may be automatically rotatable by a tension member. For example, tension member 150 may be connected between and to drive wheel 118 and a motor or motor driven actuator. In this respect, a user may operate a switch that electrically activates the motor, which, in turn, results in rotation of drive wheel 118.

According to some example embodiments, tension member 150 may be positioned within a groove 151 defined circumferentially around drive wheel 118. Groove 151 may be defined by a pair of radial side walls 158 extending circumferentially around drive wheel 118, and tension member 150 may be positioned between the pair of radial side walls 158, i.e., within groove 151, to inhibit tension member 150 from sliding off of drive wheel 118. The contact surface 152 described above may also be positioned within groove 151. In this respect, tension member 150 may engage the portion of the contact surface 152 described above within the groove 151. However, it should be appreciated that, in some embodiments, contact surface 152 may not be positioned within a groove. For example, tension member 150 may not be bounded by any walls while engaging contact surface 152.

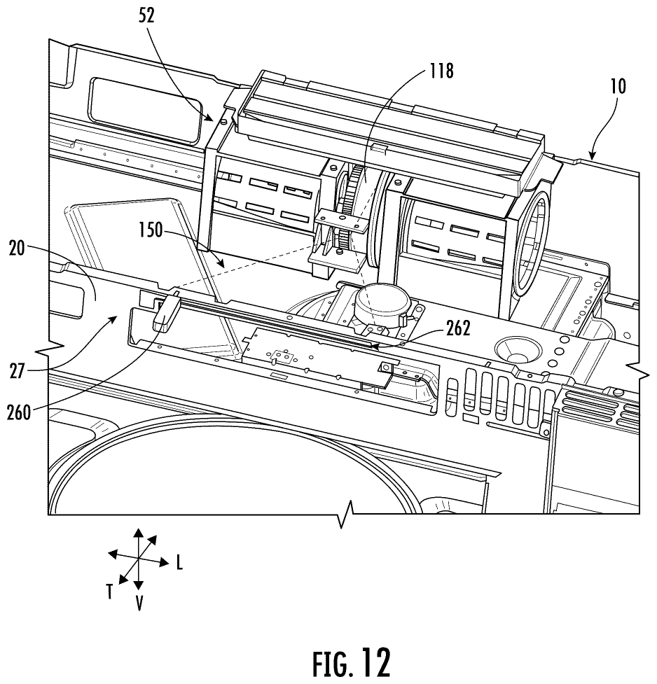

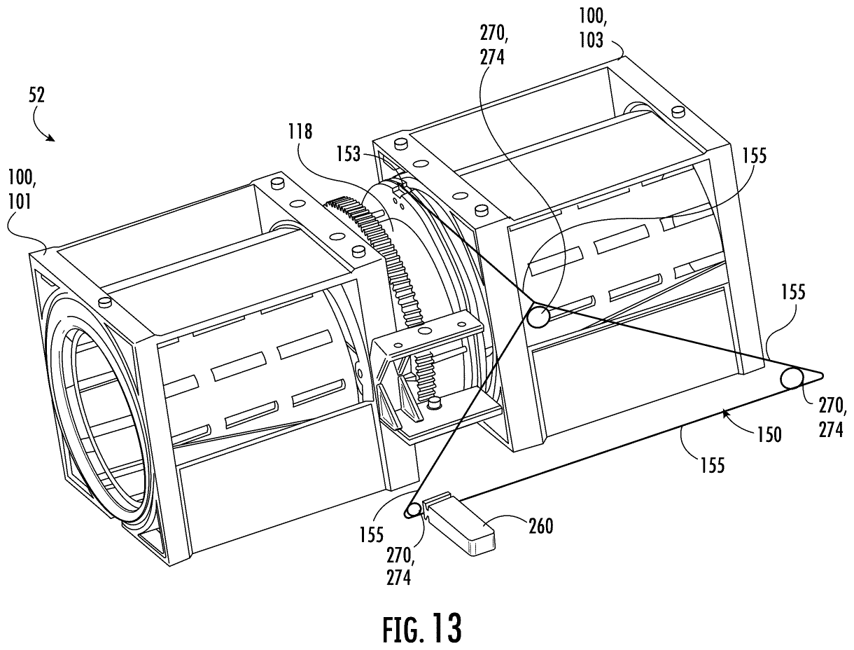

As best illustrated in FIGS. 12 and 13, in some embodiments, tension member 150 may be connected to fan control knob 260, e.g., positioned within a notch thereof, of microwave appliance 10. Additionally, fan control knob 260 may be positioned on an exterior 27 of microwave appliance 10, e.g., on front wall 21 of casing 20, for user ease of access. For example, as shown in FIG. 12, fan control knob 260 may be positioned above door 22 of microwave appliance 10 in the vertical direction V. However, it should be appreciated that the fan control knob 260 may be positioned in any other suitable location on the exterior 27 of microwave appliance 10, such as beside door 22 of microwave appliance 10, e.g., in the lateral direction L or below door 22 in the vertical direction V. Additionally, in some embodiments, it should be appreciated that the fan control knob 260 may be positioned behind an exterior panel/door (not shown) that may cover the fan control knob 260 for aesthetic purposes.

As described briefly above, the user may adjust/move the fan control knob 260. In some embodiments, for example, fan control knob 260 may be linearly slidable/slidable along a linear path, e.g., in the lateral direction L. For example, as shown in FIG. 12, a slide pathway 262 may be defined by casing 20 of microwave appliance 10 in a linear direction, e.g., lateral direction L. At least a portion of fan control knob 260 may be positioned at/on the slide pathway 262. Fan control knob 260 may be moveable/slidable, e.g., by the user, along the slide pathway 262, e.g., in the lateral direction L, between a plurality of positions. In this respect, since tension member 150 is connected to fan control knob 260, sliding of fan control knob 260 along the linear path, e.g., along slide pathway 262, moves the tension member 150 along the linear path. For example, fan control knob 260 and, thus, tension member 150, may be movable to a first position, a second position, and a third position. Markings or indicators that indicate the position of fan housing 110 and/or the direction of the flow of air F at a corresponding position of fan control knob 260 and tension member 150 may be provided, e.g., on exterior 27 of microwave appliance 10 adjacent to fan control knob 260. For example, the markings or indicators may indicate that the flow of air F is being directed to recirculate, e.g., directed through first discharge port 102, while fan control knob 260 is in the first position, that the flow of air F is directed through second discharge port 104 while fan control knob 260 is in the second position, and/or that the flow of air F is directed through third discharge port 106 while fan control knob 260 is in the third position. As such, sliding the fan control knob 260 to the first position may result in the tension member 150 moving/rotating the drive wheel 118 so that the fan housing 110 is in the first position. Additionally, sliding the fan control knob 260 to the second position may result in the tension member 150 moving/rotating the drive wheel 118 so that the fan housing 110 is in the second position. Likewise, sliding the fan control knob 260 to the third position may result in the tension member 150 moving/rotating the drive wheel 118 so that the fan housing 110 is in the third position.

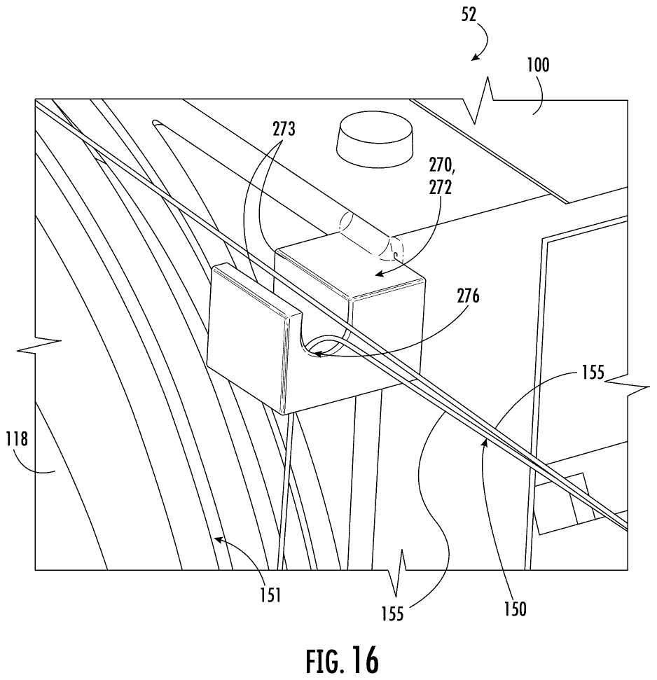

Notably, the tension member 150 may be looped through a plurality of guides 270, such as a first tension member guide 272 shown in FIG. 16 and multiple second tension member guides 274 shown in FIG. 13. The plurality of guides 270 may route the tension member 150 so that linear movement of tension member 150 is translated to rotational movement of the portion of the tension member that encircles the drive wheel 118. As such, the plurality of guides 270, particularly first tension member guide 272, permit tension member 150, e.g., a looped portion 153 thereof, to be arranged/looped circumferentially around drive wheel 118 as described above. As shown in FIG. 16, in some embodiments, first tension member guide 272 may be mounted on/to fan assembly 52, e.g., to discharge housing 100 thereof. The first tension member guide 272 may include a pair of guide walls 273 between which the tension member 150 is positioned. The pair of guide walls 273 may align the tension member 150 with a portion of the contact surface 152 of drive wheel 118, e.g., a portion of the contact surface 152 that is atop the drive wheel 118 in the vertical direction V. Additionally, first tension member guide 272 may include an arch 276. The arch 276 may define an angle, e.g., extending vertically downward at an approximately 90-degree angle, that aligns the tension member 150, e.g., the looped portion 153 thereof, with a different portion of the contact surface 152 of drive wheel 118, e.g., a portion of contact surface 152 that is on one of a front or back side of the drive wheel 118 in the transverse direction T. In this respect, first tension member guide 272 permits/guides the looped portion 153 of tension member 150 circumferentially around drive wheel 118 and facilitates alignment of tension member 150 with contact surface 152 of drive wheel 118.

Simultaneously, the plurality of guides 270, particularly second tension member guides 274 shown in FIG. 13, permit portions of tension member 150 to be linear, such as a plurality of linear portions 155, two of which are connected to the looped portion 153 as shown in FIG. 13. For example, as shown in FIG. 13, the plurality of linear portions 155 of tension member 150 may be looped through second tension member guides 274 such that a triangular shape may be defined by three of the plurality of linear portions 155 of tension member 150. Furthermore, one of the plurality of linear portions 155 of tension member 150 may be aligned, e.g., in the lateral direction L, with fan control knob 260, e.g., the notch thereof, and attached to the fan control knob 260. In this respect, movement/sliding of fan control knob 260 along the linear path as described above moves the linear portion 155 of tension member 150 attached to the fan control knob 260 along the linear path and, as such, applies a tension to and pulls/moves the linear portion 155 attached to the fan control knob 260, which rotates the drive wheel 118 in one of two rotational directions, e.g., clockwise or counterclockwise.

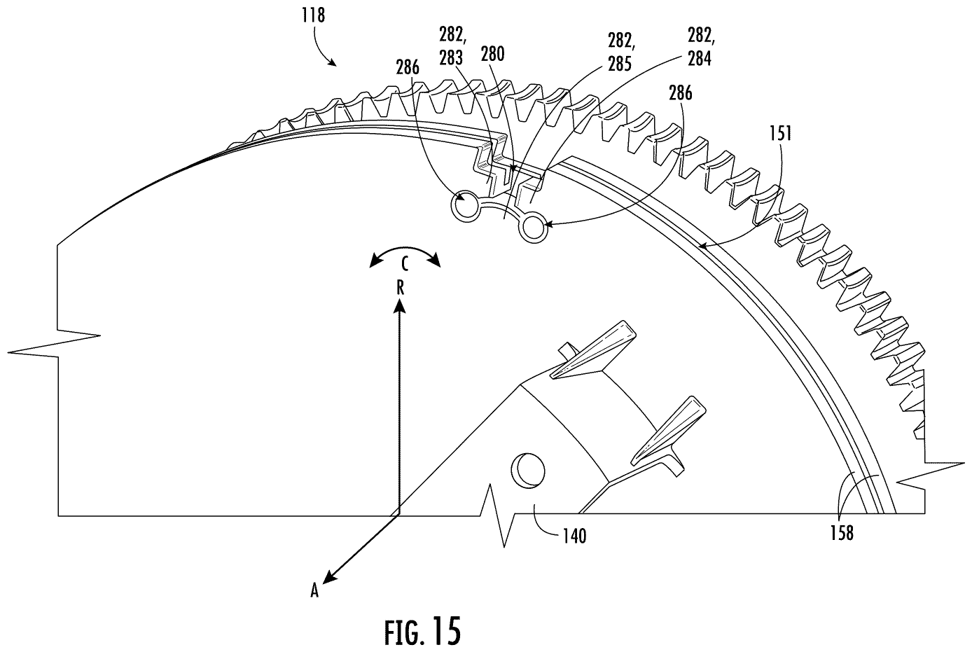

According to some example embodiments, drive wheel 118 may include a tension member retention pocket 280, which is defined through drive wheel 118. As shown in FIG. 15, the drive wheel 118 may include a plurality of tabs 282, such as three tabs 282, which may be positioned within the tension member retention pocket 280. A first tab 283 and a second tab 284 of the three tabs 282 may be spaced apart from each other along the circumferential direction C. Additionally, a third tab 285 of the three tabs 282 may be positioned below first tab 283 and second tab 284 in the radial direction R. Additionally, a plurality of sub-pockets 286, such as two sub-pockets 286, may be defined between the plurality of tabs 282. For example, one of the sub-pockets 286 may be defined between the first tab 283 and the third tab 285 while the other of the sub-pockets 286 may be defined between the second tab 284 and the third tab 285. A portion of the tension member 150 may be looped through the tension member retention pocket 280, e.g., between the plurality of tabs 282 and within the sub-pockets 286. Additionally, the plurality of tabs 282 may retain the portion of the tension member 150 that is looped through the tension member retention pocket 280 within the sub-pockets 286, thereby inhibiting the tension member 150 from slipping on/along the drive wheel 118, e.g., contact surface 152 thereof, particularly during rotation of drive wheel 118.

According to some example embodiments, each discharge housing section 101, 103 may include two aperture collars 170 that define circumferential apertures 172 (FIG. 4). An exterior surface 174 may surround each of the aperture collars 170. For example, each aperture collar 170 may include groups of walls 176, such as two groups of four walls 176, each group of which forms an orthogonal enclosed shape, e.g., a square. Each group of four walls 176 may collectively include an exterior surface 174 that surrounds one of the aperture collars 170.

Additionally, the aperture collars 170 may be aligned with or approximately parallel to the housing axis HA. The aperture collars 170 may extend circumferentially around fan housing rings 177 (FIGS. 3, 4, 17), which are fixedly coupled to the first fan housing section 113 and the second fan housing section 115 and rotatable with the fan housing sections 113, 115. For example, one aperture collar 170 of the first discharge housing section 101 and one aperture collar 170 of the second discharge housing section 103 may each extend circumferentially around different inner fan housing rings 178 (FIG. 4) one of which is coupled to the first fan housing section 113 and the other of which is coupled to the second fan housing section 115. The inner fan housing rings 178 may also be directly coupled/attached to drive wheel 118 and may be rotatable within the aperture collars 170 by drive wheel 118, thereby rotating fan housing sections 113, 115.

Referring to FIGS. 17 through 19, notably, in some example embodiments, drive wheel 118 may be rotatable, such as electromechanically rotatable. In some embodiments, for example, drive wheel 118 may be coupled to a motor drive assembly 160, such as to a gear thereof. In this respect, drive wheel 118 may include a plurality of drive wheel teeth 121, which may be circumferentially arranged or arrayed around drive wheel 118. The plurality of drive wheel teeth 121 may engage a plurality of gear teeth or threading 163 of a gear 162 of motor drive assembly 160, such as threading 164 of a worm gear 162 shown in FIGS. 17 through 19. However, while described herein as engaged with or coupled to a worm gear, it should be appreciated that drive wheel 118 may be engaged with or coupled to any suitable gear, such as a helical gear, bevel gear, spur gear, or the like.

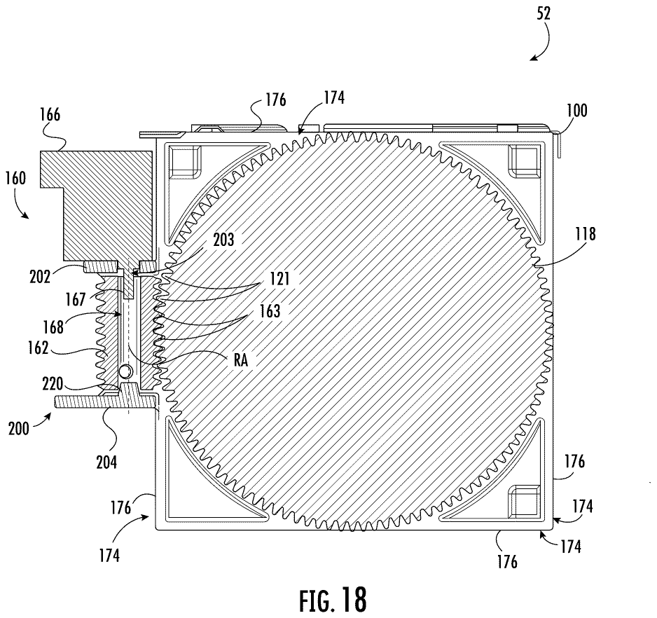

Additionally, the motor drive assembly 160 includes a motor 166, such as a stepper motor. The gear 162 may be coupled to motor 166. For example, as best illustrated in FIG. 18, an axial passage 168 may be defined partially or entirely through gear 162. The axial passage 168 may be aligned with a rotational axis RA of gear 162. A drive shaft 167 may extend from motor 166 that is rotatable by motor 166. When gear 162 is coupled to motor 166, drive shaft 167 may be aligned with and extend into/be received within axial passage 168 of gear 162 and fixed to gear 162. In this respect, gear 162 may be moved/rotated by motor 166. Movement/rotation of the gear 162, e.g., by motor 166, rotates drive wheel 118 and, thus, fan housing 110. As described above, motor 166 may be in operative communication with controller 60. As such, a user may activate motor 166 from controls 26 of microwave appliance 10 and/or from a dedicated fan user interface (not shown) of microwave appliance 10 and/or from a remote user interface device, e.g., tablet, smartphone, wirelessly connected to controller 60. In this respect, a user may select/choose between rotating the drive wheel 118 and, thus, the fan housing 110 with tension member 150 as described above or, alternatively, by activating motor 166 as described herein.

According to some example embodiments, fan assembly 52 includes a gear mounting structure 200 for supporting the gear 162 thereon while permitting rotation of the gear 162. The gear mounting structure 200 may be positioned on and attached to discharge housing 100. For example, as shown in FIGS. 17 through 19, gear mounting structure 200 may be attached to the exterior surface 174 described above, such as the exterior surface 174 surrounding one of the aperture collars 170 extending circumferentially around one of the inner fan housing rings 178 described above. Specifically, the gear mounting structure 200 may be positioned on and attached to such exterior surface 174 on the front side 128 of discharge housing 100. However, it should be appreciated that gear mounting structure 200 may be positioned on and attached to discharge housing 100 on any suitable side of discharge housing 100. As such, gear mounting structure 200 and, thus, the gear 162, may be positioned for desired engagement/contact between the gear 162 and drive wheel 118. In some embodiments, gear mounting structure 200 may be integrally coupled or formed with discharge housing 100 as a continuous piece, e.g., as a single continuous and monolithic piece forming a unitary body whereby the gear mounting structure 200 and the discharge housing 100 are integrally joined together without fasteners.

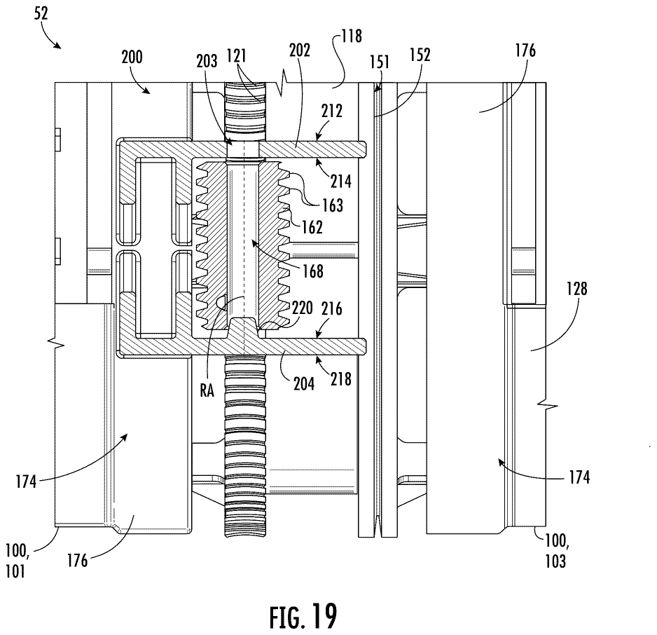

According to some example embodiments, gear mounting structure 200 may include a first flange, described herein as an upper flange 202, and a second flange, described herein as a lower flange 204 spaced apart from the upper flange 202, e.g., in the vertical direction V. While described herein as upper and lower flanges, it should be appreciated that the first flange and the second flange may be oriented in any suitable direction. For example, in some embodiments, the first flange and the second flange may be positioned on the top side 120 of discharge housing 100 and, thus, spaced apart from each other in a non-vertical direction, e.g., the transverse direction T. As best illustrated in FIG. 19, upper flange 202 may include a first or upper surface 212 and a second or lower surface 214 spaced apart from each other, e.g., in the vertical direction V. Likewise, lower flange 204 may include a first or upper surface 216 and a second or lower surface 218 spaced apart from each other, e.g., in the vertical direction V. As illustrated, the lower surface 214 of the upper flange 202 faces or opposes the upper surface 216 of the lower flange 204. Furthermore, as illustrated in FIGS. 17 through 19, the gear 162 may be positioned or sandwiched between the upper surface 216 of the lower flange 204 and the lower surface 214 of the upper flange 202. The rotational axis RA of the gear 162, which is described herein as a worm gear 162, may be approximately perpendicular to the upper flange 202 and the lower flange 204. Furthermore, threads 163 of worm gear 162 may protrude from underneath the flanges 202, 204 to engage the plurality of drive wheel teeth 121 of drive wheel 118 without interference of the plurality of drive wheel teeth 121 with the flanges 202, 204.

Additionally, in some embodiments, the motor 166 may be mounted to either the upper flange 202 or the lower flange 204, such as to the upper surface 212 of the upper flange 202. As best illustrated in FIG. 18, a shaft aperture 203 may be defined through the upper flange 202 through which the drive shaft 167 is received. Furthermore, drive shaft 167, shaft aperture 203, and axial passage 168 of gear 162 may all be aligned. In this respect, drive shaft 167 may be simultaneously received through shaft aperture 203 of upper flange 202 and axial passage 168 of gear 162.

According to some example embodiments, gear mounting structure 200 also includes a support 220 for supporting gear 162 thereon and for permitting rotation of gear 162 about rotational axis RA. Support 220 may protrude from either the upper flange 202, e.g., the lower surface 214 thereof, or the lower flange 204, e.g., the upper surface 216 thereof. For example, as shown in FIGS. 18 and 19, the support protrudes from the upper surface 216 of the lower flange 204. As illustrated, the support 220 may be received within the axial passage 168 of gear 162 and, thus, support gear 162 thereon. Additionally, support 220 may be axially aligned with, e.g., in the vertical direction, rotational axis RA of gear 162. Furthermore, support 220 may include a rounded outer surface, such as a circular or cylindrical outer surface to permit and facilitate rotation of gear 162 about support 220 and, thus, rotational axis RA. Moreover, in some embodiments, the support 220 and the drive shaft 167 are simultaneously received within axial passage 168 of gear 162 at different ends of gear 162 to provide support for gear 162. For example, drive shaft 167 may be received through axial passage 168 of gear 162 at a top end of gear 162 while support 220 is received through axial passage 168 of gear 162 at a bottom end of gear 162, which is spaced apart from top end of gear 162, e.g., in the vertical direction V.

While described here as moving/rotating due to movement of a motor drive assembly, e.g., motor drive assembly 160, it should be appreciated that gear 162 and, thus, drive wheel 118, may be manually rotated, such as by a fan control dial mechanically coupled to gear 162, whereby turning the fan control knob, e.g., by a user, directly rotates the gear 162 and, thus, drive wheel 118.

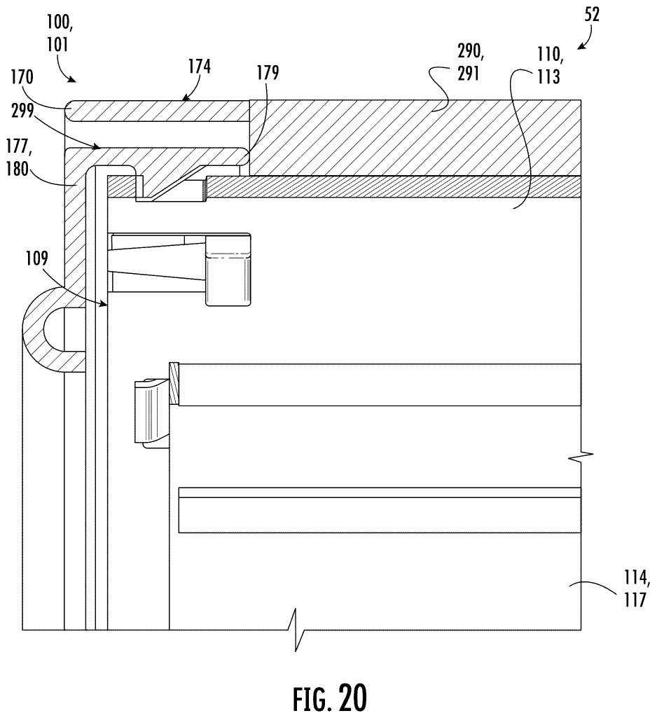

Referring now to FIGS. 20 through 22, according to some example embodiments, fan assembly 52 further includes the fan housing rings 177 described above, which are fixed to the fan housing 110 and, thus, rotatable with fan housing 110. The fan housing rings 177 include the inner fan housing rings 178 described above, which are positioned around inner ends 107 (FIG. 10) of the fan housing 110, e.g., one of each fan housing section 113, 115. The fan housing rings 177 also include outer fan housing rings 180, e.g., two outer fan housing rings 180, which are positioned around outer ends 109 of the fan housing 110, e.g., one of each fan housing section 113, 115. Each fan housing ring 177, e.g., each inner fan housing ring 178 and each outer fan housing ring 180, may be positioned at least partially within discharge housing 100. For example, each fan housing ring 177 may be positioned within a different aperture collar 170, each of which extends circumferentially around one of the fan housing rings 177. The fan housing rings 177, e.g., the inner fan housing rings 178 and the outer fan housing rings 180, may be rotatable within the aperture collars 170 and, thus, relative to discharge housing 100.

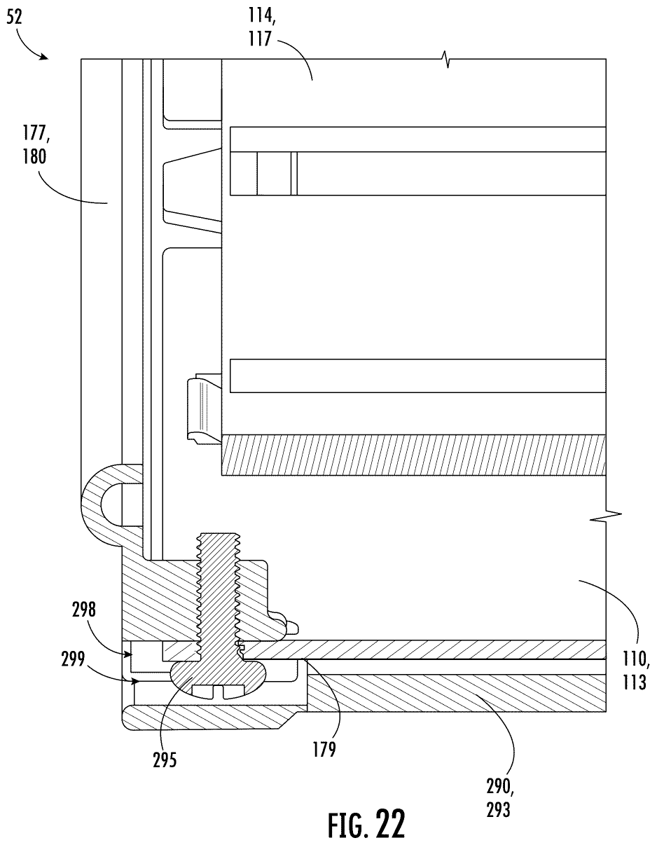

According to some example embodiments, each fan housing ring 177, e.g., the inner fan housing rings 178 and the outer fan housing rings 180, includes an inner edge 179 (FIGS. 20, 22). Inner edge 179 of each fan housing ring 177 may extend circumferentially around the fan housing ring 177. The inner edge 179 of each fan housing ring 177 may be configured to contact a surface of discharge housing 100 to locate the fan housing ring 177 and to constrain or limit movement of components of the fan assembly 52, such as movement of each discharge housing section 101, 103 relative to each other and/or movement of each discharge housing section 101, 103 relative to each respective fan housing section 113, 115. For example, each discharge housing section 101, 103 may include one or more plates 290 (FIGS. 4, 20, 22). For example, as best illustrated in FIG. 4, each discharge housing section 101, 103 may include a first plate 291, a second plate 292, a third plate 293, and a fourth plate 294. The first plate 291 may extend across the top side 120 of discharge housing 100 between each group of walls 176 of the discharge housing section 101 or 103. The second plate 292 may extend across the back side 132 of discharge housing 100 between each group of walls 176 of the discharge housing section 101 or 103. The third plate 293 may extend across the bottom side 122 of discharge housing 100 between each group of walls 176 of the discharge housing section 101 or 103. The fourth plate 294 may extend across the front side 128 of discharge housing between each group of walls 176 of the discharge housing section 101 or 103. Each plate 290 may extend inward, e.g., in radial direction R, beyond or past the aperture collar 170. For example, the first plate 291 may extend radially inward or vertically below the aperture collar 170.

In some embodiments, the inner edges 179 of the fan housing rings 177 may contact one or more of the plates 290. Moreover, the plates 290 in contact with the inner edges 179 of the fan housing rings 177 may be sandwiched between two of the fan housing rings 177. For example, the first plate 291 of the first discharge housing section 101 may be sandwiched between the inner edge 179 of the inner fan housing ring 178 of the first discharge housing section 101 and the inner edge 179 of the outer fan housing ring 180 of the first discharge housing section 101. Likewise, the first plate 291 of the second discharge housing section 103 may be sandwiched between the inner edge 179 of the inner fan housing ring 178 of the second discharge housing section 103 and the inner edge 179 of the outer fan housing ring 180 of the second discharge housing section 103. In this respect, the movement of components of fan assembly 52 are constrained/limited. For example, movement of each discharge housing section 101, 103 relative to each respective fan housing section 113, 115 is constrained/limited. Likewise, since each fan housing section 113, 115 is fixedly coupled to its respective fan housing rings 177 and the inner fan housing rings 178 are fixedly coupled to the drive wheel 118, the movement of each discharge housing section 101, 103 relative each other is constrained/limited.

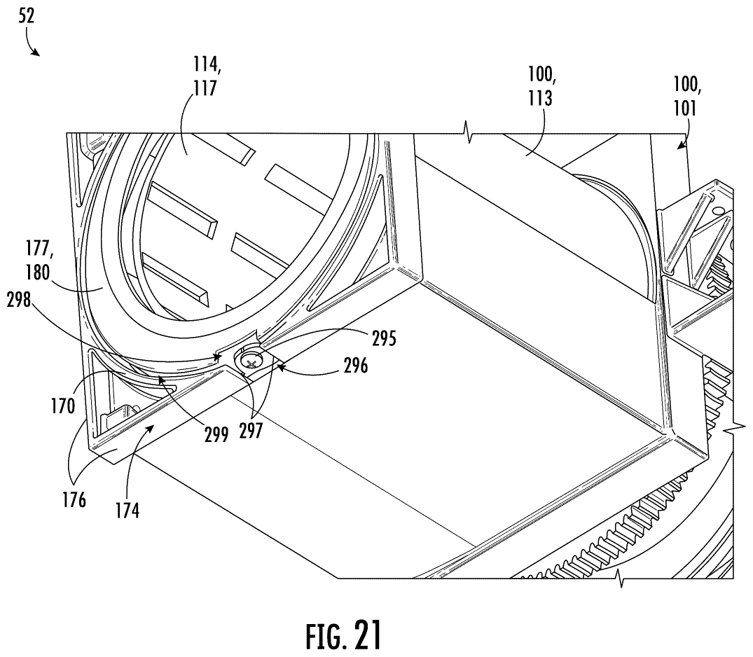

Referring specifically to FIGS. 21 and 22, one or more coupling elements 295 may be utilized to fixedly connect fan housing 110 to the fan housing rings 177. The discharge housing 100 also includes features for limiting interference of the coupling elements with other features or components of the discharge housing 100, particularly during rotation of the fan housing 110 and, thus, rotation of the fan housing rings 177. In some embodiments, the coupling element(s) 295 includes a fastener, such as a bolt(s) 295 as shown in FIGS. 21 and 22. However, it should be appreciated that the coupling element(s) 295 may be any other suitable coupling element(s) such as screws, rivets, clips, and/or the like. As shown in FIGS. 21 and 22, each bolt 295 may extend simultaneously through the fan housing 110 and one of the fan housing rings 177, such as through aligned apertures of the fan housing 110 and the fan housing rings 177, so that the fan housing 110 and the fan housing rings 177 are fixed together.

According to some example embodiments, a coupling element access slot 296 is defined within/through the aperture collar 170, e.g., through one of the walls of the group of walls 176 thereof. For example, as best illustrated in FIG. 21, the coupling element access slot 296 may be defined between two opposing edges 297 of aperture collar 170, e.g., edges 297 of one of the walls of the group of walls 176. During rotation of the fan housing 110, the bolt(s) 295 or other coupling element(s) 295 may be exposed/revealed within the coupling element access slot 296 or concealed within/by the aperture collar 170. Additionally, as best illustrated in FIGS. 21 and 22, each fan housing ring 177, e.g., the outer fan housing ring 180, may include a recessed portion 298 positioned radially inward from an outer surface 299 of the fan housing ring 177. The coupling element(s) 295 may extend through the fan housing ring 177 at the recessed portion 298 as shown in FIG. 21 and, thus, the coupling element(s) 295 may be positioned within the recessed portion 298. In this respect, interference between the coupling element(s) 295 and other components of the fan assembly 52, such as the plates 290 of the discharge housing 100, may be avoided.

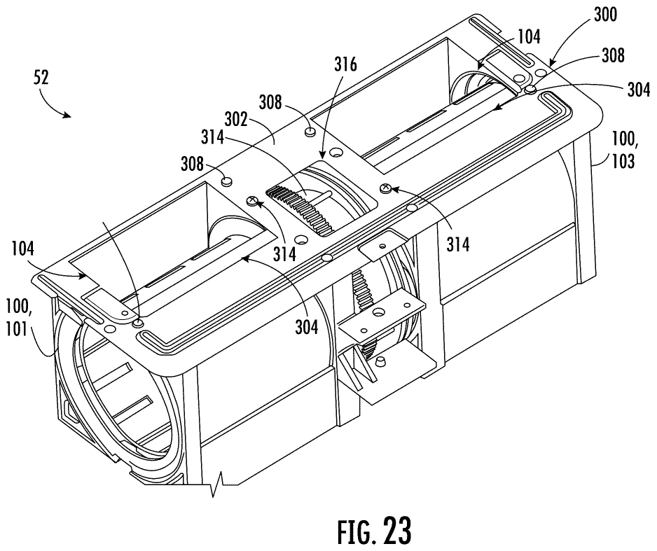

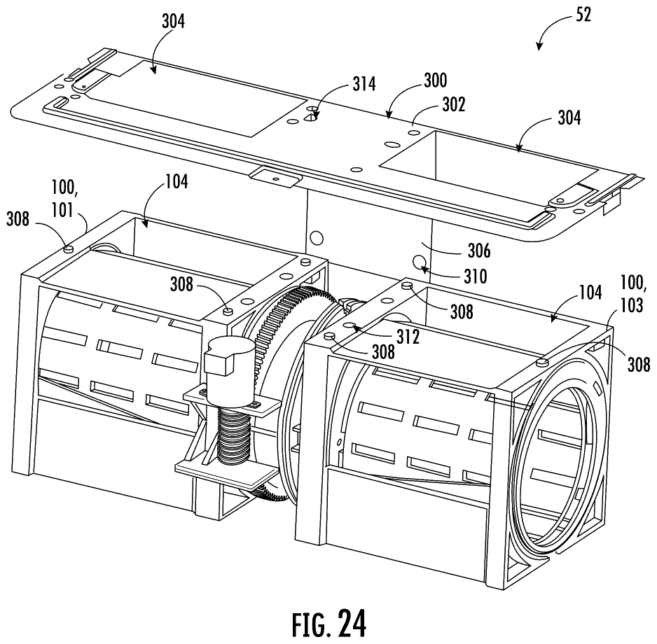

Referring to FIGS. 23 through 26, a blower bracket 300 of the fan assembly 52 is described. The blower bracket 300 may be utilized to align various other components of the fan assembly 52 and to provide structure to the fan assembly 52. As shown in FIGS. 23 and 24, blower bracket 300 may include a first plate, described herein as a primary plate 302, that generally defines a blower bracket discharge port 304. As shown in FIGS. 23 and 24, the blower bracket discharge port 304 may be defined as a pair of blower bracket discharge ports 304, such as one port on each section of blower bracket 300 forming a pair of blower bracket discharge ports 304. As shown in FIG. 23, the blower bracket 300 is positioned on and attached to the discharge housing 100, particularly so that the each of the pair of blower bracket discharge ports 304 is aligned with a different discharge port of one of the pair of discharge ports, e.g., the second discharge ports 104, of the discharge housing 100. In this respect, the flow of air F is permitted to flow out of discharge ports, e.g., the second discharge ports 104, of discharge housing 100, e.g., in the vertical direction V, and out of the blower bracket discharge ports 304 such that flow of air F may flow out of the external duct or recirculated through circulation conduit 46.

According to some example embodiments, in addition to the primary plate 302 described above, blower bracket 300 may also include a second plate, described herein as a secondary plate 306. The secondary plate 306 may be positioned between an aligned pair of discharge ports, e.g., third discharge ports 106, of the discharge housing 100 so that the flow of air F from the discharge ports is not blocked by the secondary plate 306. The secondary plate 306 may be coupled to and extend from the primary plate 302. In some embodiments, secondary plate 306 may be integrally coupled or formed with primary plate 302 as a continuous piece, e.g., as a single continuous and monolithic piece forming a unitary body whereby the secondary plate 306 and the primary plate 302 are integrally joined together without fasteners. Additionally, in some embodiments, the secondary plate 306 may extend orthogonally from primary plate 302. In this respect, secondary plate 306 may be approximately perpendicular to primary plate 302. As such, primary plate 302 and secondary plate 306 may collectively form or define an L-shaped blower bracket. However, while described herein as including secondary plate 306, it should be appreciated that in some embodiments, blower bracket 300 may include only one plate, e.g., only primary plate 302 or only secondary plate 306.

According to some example embodiments, blower bracket 300 may be positioned on first discharge housing section 101 of discharge housing 100 and second discharge housing section 103 of discharge housing 100 simultaneously. As such, primary plate 302 may span a gap between first discharge housing section 101 and second discharge housing section 103 within which drive wheel 118 is positioned. In some embodiments, primary plate 302 may span a distance of an entire side, e.g., entire top side 120, of discharge housing 100. Furthermore, secondary plate 306 may be positioned on a different side, e.g., back side 132, of discharge housing 100 than primary plate 302. Additionally, in some embodiments, secondary plate 306 may also span the gap between first discharge housing section 101 and second discharge housing section 103 within which drive wheel 118 is positioned. Moreover, in some embodiments, the blower bracket 300, e.g., primary plate 302 and secondary plate 306, may be symmetrical across drive wheel 118.

Furthermore, blower bracket 300 may be simultaneously coupled to first discharge housing section 101 and second discharge housing section 103. In this respect, blower bracket 300 may provide structure and support for fan assembly 52, particularly discharge housing 100 thereof. In particular, blower bracket 300 may constrain or prevent relative movement between the first discharge housing section 101 and the second discharge housing section 103.

According to some example embodiments, blower bracket 300 may be made, at least partially, from any suitable rigid or flexible fire-retardant metal material, such as steel, nickel, titanium, iron, or some metal alloy combination thereof. Additionally, the blower bracket 300 may be made, at least partially, using hot-rolled metal, cold-rolled metal, cast iron, and/or stainless steel.

In some embodiments, a plurality of blower bracket locating protrusions 308 may protrude from one or both of the blower bracket 300, e.g., from primary plate 302 and/or secondary plate 306, and the discharge housing 100, e.g., from exterior surface(s) 174 of aperture collar(s) 170 of first discharge housing section 101 and/or of second discharge housing section 103. For example, as best illustrated in FIG. 24, the plurality of blower bracket locating protrusions 308 may all protrude from the discharge housing 100. In particular, some of the blower bracket locating protrusions 308 protrude from the exterior surfaces 174 of all aperture collars 170 on the top side 120 of discharge housing 100 for coupling the blower bracket 300 to the discharge housing 100 at the primary plate 302. For example, as shown in FIG. 24 two blower bracket locating protrusions 308 may protrude from the exterior surface 174 of the aperture collar 170 surrounding the inner fan housing ring 178 of the first discharge housing section 101. The two blower bracket locating protrusions may be transversely spaced apart from each other. Additionally, as shown in FIG. 24 two different blower bracket locating protrusions 308 may protrude from the exterior surface 174 of the aperture collar 170 surrounding the inner fan housing ring 178 of the second discharge housing section 103. The two blower bracket locating protrusions may be transversely spaced apart from each other. Likewise, some or the rest of blower bracket locating protrusions (not shown) may protrude from the exterior surfaces 174 of the aperture collars 170 surrounding the inner fan housing rings 178 on the back side 132 of discharge housing 100 for coupling the blower bracket 300 to the discharge housing 100 at the secondary plate 306.

Additionally, each blower bracket locating protrusion 308 may be received through a different locating protrusion aperture 310 of a plurality of locating protrusion apertures 310. As shown in FIG. 24, the locating protrusion apertures 310 may all be defined through the blower bracket 300, some through primary plate 302 and some through secondary plate 306. Hower, it should be appreciated that, in some embodiments, some or all of the locating protrusion apertures 310 may be defined through the discharge housing 100. As shown in FIGS. 23 and 24, the locating protrusion apertures 310 may all be simultaneously aligned with and received through respective blower bracket locating protrusions 308. Additionally, as best illustrated in FIGS. 23 and 24, in some embodiments, a plurality of blower bracket fastener apertures 312 and a plurality of discharge housing fastener apertures 314 may be defined through the blower bracket 300, e.g., the primary plate 302 thereof, and the discharge housing 100, e.g., the exterior surfaces 174 of the aperture collars 170 of first discharge housing section 101 and second discharge housing section 103, respectively. As shown in FIG. 23, each of the plurality of blower bracket fastener apertures 312 may be aligned with a different one of the plurality of discharge housing fastener apertures 314 and a fastener, e.g., bolt, screw, and/or the like, may be received simultaneously through both apertures 312, 314 to secure the blower bracket 300 to the discharge housing 100. As such, the blower bracket 300, the first discharge housing section 101, and the second discharge housing section 103 may be fixedly coupled together. In this respect, relative movement between the first discharge housing section 101, the second discharge housing section 103, and the blower bracket 300 is constrained or prevented.

According to some example embodiments, blower bracket 300 may include one or more drive wheel tolerance apertures 316 (FIG. 23) that are defined through the blower bracket 300. For example, blower bracket 300 may include one drive wheel tolerance aperture 316 that is defined through primary plate 302. As shown, the drive wheel tolerance aperture 316 may be positioned over the gap between the first discharge housing section 101 and the second discharge housing section 103, which is the gap within which the drive wheel 118 is positioned. As such, the drive wheel 118 may be aligned with the drive wheel tolerance aperture 316 while the blower bracket 300 is located/positioned on the first discharge housing section 101 and the second discharge housing section 103. The drive wheel tolerance aperture 316 may permit various drive wheels with differing diameters to be utilized without interference with the blower bracket 300. For example, some drive wheels may protrude beyond, e.g., radially outside of or vertically above, the exterior surfaces 174 of the aperture collars 170. As such, the drive wheel tolerance aperture 316 may permit a portion of a drive wheel to protrude through the blower bracket 300 to avoid interference between the drive wheel and the blower bracket 300.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A cooking appliance, comprising:
a casing defining a cooking chamber for receipt of food items for cooking and a circulation conduit, the circulation conduit including an inlet and an outlet;
a door mounted to the casing for permitting selective access to the cooking chamber; and
a fan assembly positioned within the circulation conduit, the fan assembly comprising:
a discharge housing comprising:
a first discharge housing section;
a second discharge housing section spaced apart from the first discharge housing section; and
a discharge port defined through at least one of the first discharge housing section or the second discharge housing section;
an impeller rotatably mounted within the discharge housing, whereby rotation of the impeller circulates air through the discharge port; and
a blower bracket comprising a first plate and a second plate coupled to and extending orthogonally from the first plate, the blower bracket positioned on and coupled to the first discharge housing section and the second discharge housing section, whereby relative movement between the first discharge housing section, the second discharge housing section, and the blower bracket is constrained.

2. The cooking appliance of claim 1, the blower bracket comprising:
a blower bracket discharge port defined through the first plate, whereby the blower bracket discharge port is aligned with the discharge port of the discharge housing.

3. The cooking appliance of claim 1, wherein:
a plurality of blower bracket locating protrusions protrude from at least one of the discharge housing or the blower bracket; and
each locating protrusion of the plurality of blower bracket locating protrusions is received through a different locating protrusion aperture of a plurality of locating protrusion apertures, whereby relative movement between the first discharge housing section, the second discharge housing section, and the blower bracket is constrained.

4. The cooking appliance of claim 1, wherein:
the discharge port is one of a plurality of discharge ports of the discharge housing; and
the fan assembly further comprises a fan housing comprising an outlet, the fan housing mounted within the discharge housing, the fan housing selectively rotatable within the discharge housing to align the outlet with a selected one of the plurality of discharge ports.

5. The cooking appliance of claim 4, wherein the plurality of discharge ports comprises three discharge ports facing in three different directions.

6. The cooking appliance of claim 5, wherein the discharge housing is defined between a top side, a bottom side, a first side wall, a second side wall, a front side, and a back side.

7. The cooking appliance of claim 6, wherein one of the three discharge ports is positioned on the top side, one of the three discharge ports is positioned on the front side, and one of the three discharge ports is positioned on the back side.

8. The cooking appliance of claim 7, wherein:
the one of the three discharge ports that is positioned on the top side is aligned with a circulation conduit of the casing; and
the blower bracket comprises a blower bracket discharge port defined therethrough, whereby the blower bracket discharge port is aligned with the one of the three discharge ports that is positioned on the top side of the discharge housing.

9. The cooking appliance of claim 4, the fan assembly further comprising:
the fan assembly further comprises a drive wheel coupled to the fan housing, whereby rotation of the drive wheel rotates the fan housing, the drive wheel positioned between the first discharge housing section and the second discharge housing section; and
the blower bracket comprises a tolerance aperture defined through the blower bracket, whereby the drive wheel is aligned with the tolerance aperture while the blower bracket is positioned on the first discharge housing section and the second discharge housing section.

10. The cooking appliance of claim 1, wherein the blower bracket is comprised of metal.

11. A cooking appliance, comprising:
a casing defining a cooking chamber for receipt of food items for cooking and a circulation conduit, the circulation conduit including an inlet and an outlet;
a door mounted to the casing for permitting selective access to the cooking chamber; and
a fan assembly positioned within the circulation conduit, the fan assembly comprising:
a discharge housing comprising:
a first discharge housing section;
a second discharge housing section spaced apart from the first discharge housing section; and
a discharge port defined through at least one of the first discharge housing section or the second discharge housing section;
an impeller rotatably mounted within the discharge housing, whereby rotation of the impeller circulates air through the discharge port; and
a blower bracket positioned on and coupled to the first discharge housing section and the second discharge housing section, whereby relative movement between the first discharge housing section, the second discharge housing section, and the blower bracket is constrained.

12. The cooking appliance of claim 11, the blower bracket comprising:
a blower bracket discharge port defined therethrough, whereby the blower bracket discharge port is aligned with the discharge port of the discharge housing.

13. The cooking appliance of claim 12, the blower bracket further comprising:
a first plate, the blower bracket discharge port defined through the first plate; and
a second plate coupled to and extending orthogonally from the first plate.

14. The cooking appliance of claim 11, wherein:
a plurality of blower bracket locating protrusions protrude from at least one of the discharge housing or the blower bracket; and
each locating protrusion of the plurality of blower bracket locating protrusions is received through a different locating protrusion aperture of a plurality of locating protrusion apertures, whereby relative movement between the first discharge housing section, the second discharge housing section, and the blower bracket is constrained.

15. The cooking appliance of claim 11, wherein:
the discharge port is one of a plurality of discharge ports of the discharge housing; and
the fan assembly further comprises a fan housing comprising an outlet, the fan housing mounted within the discharge housing, the fan housing selectively rotatable within the discharge housing to align the outlet with a selected one of the plurality of discharge ports.

16. The cooking appliance of claim 15, wherein the plurality of discharge ports comprises three discharge ports facing in three different directions.

17. The cooking appliance of claim 16, wherein the discharge housing is defined between a top side, a bottom side, a first side wall, a second side wall, a front side, and a back side.

18. The cooking appliance of claim 17, wherein one of the three discharge ports is positioned on the top side, one of the three discharge ports is positioned on the front side, and one of the three discharge ports is positioned on the back side.

19. The cooking appliance of claim 18, wherein:
the one of the three discharge ports that is positioned on the top side is aligned with a circulation conduit of the casing; and
the blower bracket comprises a blower bracket discharge port defined therethrough, whereby the blower bracket discharge port is aligned with the one of the three discharge ports that is positioned on the top side of the discharge housing.

20. The cooking appliance of claim 15, wherein
the fan assembly further comprises a drive wheel coupled to the fan housing, whereby rotation of the drive wheel rotates the fan housing, the drive wheel positioned between the first discharge housing section and the second discharge housing section; and
the blower bracket comprises a tolerance aperture defined through the blower bracket, whereby the drive wheel is aligned with the tolerance aperture while the blower bracket is positioned on the first discharge housing section and the second discharge housing section.
